(19) United States
(12) Patent Application Publication
(10) Pub. No.: US 2009/0316850 A1
(43) Pub. Date: Dec. 24, 2009

(54) Generating short-term criticality in a sub-critical reactor

(76) Inventor: James R. Langenbrunner, Santa Fe, NM (US)

Correspondence Address: COCHRAN FREUND & YOUNG LLC, 2026 CARIBOU DR, SUITE 201, FORT COLLINS, CO, 80525, US

(21) Appl. No.: 11/482,327

(22) Filed: Jul. 7, 2006

Related U.S. Application Data
(63) Continuation of application No. 10/464,441, filed on Jun. 19, 2003, now abandoned.

(51) Int. Cl. G21G 1/06; G21G 1/10

(52) U.S. Cl. 376/199; 376/185

(57) ABSTRACT

Disclosed are apparatus and method of providing accurate control of a nuclear reactor containing fuel and designed to be subcritical in the static case that has a vessel, the vessel defining a shell, and an internal volume containing the fuel. A fusion target is located in the internal volume and contains a reactive material. A pulsed source of a hydrogen isotope directs the hydrogen isotope into, but stopping within the fusion target. Each pulse of a hydrogen isotope produces a pulse of neutrons from the reactive material in the fusion target that scatter into and burn the fuel, and thereafter the reactor returns to the static case.

### CROSS REFERENCE TO RELATED APPLICATIONS

This patent application is a continuation of U.S. patent application Ser. No. 10/464,441 entitled “Generating Short-Term Criticality in a Sub-Critical Reactor” by James R. Langenbrunner, filed on Jun. 19, 2003, the entire disclosure of which is hereby specifically incorporated by reference herein for all that it discloses and teaches.

### STATEMENT REGARDING FEDERAL RIGHTS

The present invention was made with government support under Contract No. W-7405-ENG-36. The government has certain rights in the invention.

### FIELD OF THE INVENTION

The present invention generally relates to nuclear reactor kinetics, manipulation of the energy spectrum of neutrons in a reactor, and by extension, nuclear fuel types and fuel cycles, and more specifically to the precise control of nuclear criticality in order to burn plutonium or increase efficiency and maximize the use of nuclear fuel.

### BACKGROUND OF THE INVENTION

There exists an abundance of weapons plutonium, ²³⁹Pu, from nuclear disarmament activities throughout the world. It poses a problem if not properly protected due to the fact that terrorists can use it to make fearsome weapons. At the same time, the nuclear power industry fears using ²³⁹Pu in a critical reactor; ²³⁹Pu is a proliferant material superior for the use of weapons. It would be beneficial to have a method of burning such fuel so that it is intractable for use by terrorists.

Furthermore, fuel rods used in many present nuclear power plants, are removed from service with approximately one-third of their available fissile isotope remaining. At the end of a fuel rod's life, it may contain approximately 0.5% by weight of ²³⁹Pu, which, while it adds to the fuel's reactivity, is detrimental. When these used fuel rods are removed from service, they must be stored in some type of interim repository. It also would be beneficial to have a method of burning the ²³⁹Pu in the rods instead of storing these in an interim repository. In any case, only using two-thirds of the fuel in a rod is not a particularly efficient use of the material. It would be extremely beneficial to have a reactor installation to which the ²³⁹Pu from weapons disarmament and/or “spent” fuel rods could be sent in order to use the ²³⁹Pu fuel and be rendered much less attractive to persons desiring to make weapons of mass destruction.

The present invention provides a nuclear reactor that through control of its criticality, can burn ²³⁹Pu, thus making the bulk of the fuel less usable by terrorists. This is accomplished through pulsing the nuclear material with reactant neutrons from a fusion reaction.

It is helpful in the understanding of the present invention to review the state of the art regarding transmutation of reactor actinide elements. The following equation describes the basic neutronics of sub-critical systems:

k_{eff}=n/(1+A+P+L), 10

where n is the average number of neutrons released by each fission, A is the ratio of neutron absorption to fission cross section in the active component of the fuel, P is the number of neutrons parasitically absorbed in the system per fission, L is the number of neutrons leaving the system through leakage per fission. The reactivity of the system, k_{eff}, is related to the system neutron multiplication, M, by the following equation:

M=1/(1−k_{eff}), 11

Critical (self-driven) static systems with k_{eff}=1 have infinite neutron multiplication.

If, for example, a transmutation apparatus operated with a fast neutron spectrum (a lead-based system, where k_{eff}=0.75) then the values for the parameters are: A=1.4; P=0.4; n<3. In other apparatus configurations, values of n substantially larger than 3 may be possible. In such a transmutation apparatus, a substantial number of fissions would be initiated by high-energy spallation neutrons, and these would be deeply sub-critical systems.

In the present invention, a reactor, whether commercial or for research, can be efficiently pulsed to burn ²³⁹Pu and/or produce power. As will be discussed, this is accomplished through periodic pulsing the reactor from a sub-critical state to a critical or supercritical state and then having it return to the sub-critical state after the pulse is over.

### SUMMARY OF THE INVENTION

To achieve the objects of the invention and in accordance with the purpose of the present invention, as embodied and broadly described herein, apparatus for providing accurate control of a nuclear reactor containing fuel and designed to be subcritical in the static case comprising: a vessel, the vessel defining a shell, and an internal volume containing the fuel. A fusion target is located in the internal volume, the fusion target containing a reactive material. A pulsed source of a hydrogen isotope, directs a hydrogen isotope into, but stopping within the fusion target. Wherein each pulse of a hydrogen isotope produces a pulse of neutrons from the reactive material in the fusion target that scatter into and burn the fuel, and thereafter the reactor returns to the static case.

In a further aspect of the present invention, and in accordance with its principles and purposes, apparatus for providing accurate control of a nuclear reactor comprises a vessel, the vessel defining a shell, a window and an internal volume containing a fuel. A fusion target is located in the internal volume, the fusion target containing a reactive material. A pulsed source of a hydrogen isotope directs the hydrogen isotope through the window and into, but stopping within the fusion target. Wherein each pulse of a hydrogen isotope produces a pulse of neutrons from the reactive material in the fusion target that scatter into and burn the fuel, and thereafter the reactor returns to the static case.

In a still further aspect of the present invention, and in accordance with its principles and purposes, a method of providing accurate control of a nuclear reactor containing fuel and designed to be subcritical in the static case comprises the step of directing pulses of a hydrogen isotope through a window of a vessel containing fuel, and into a fusion target located in the vessel, the fusion target containing a reactive material, with the pulses of hydrogen isotope stopping within the fusion target; wherein each pulse of a hydrogen isotope produces a pulse of neutrons from the reactive material in the fusion target that scatter into and burn the fuel, and thereafter the reactor returns to the static case.

### BRIEF DESCRIPTION OF THE DRAWINGS

The accompanying drawings, which are incorporated in and forms a part of the specification, illustrate embodiments of the present invention and, together with the description, serve to explain the principles of the invention. In the drawings:

FIGS. 1 A and 1 B are graphs illustrating the operation of the kinetics of an embodiment of the present invention in pulsing a reactor from sub-criticality to supercriticality and then returning to sub-criticality after the end of the pulse.

FIG. 2 is a schematic illustration of an embodiment of the present invention.

### DESCRIPTION OF THE INVENTION

The present invention provides a nuclear reactor, for commercial, research, or military use that is normally sub-critical, but has the means for impingement of a hydrogen isotope beam upon a fusion target. The reactor of the present invention must be allowed to be sub-critical by design of its geometry (and the type of fuel) before and at a sufficient time after the hydrogen isotope beam is energized. Pulses of beam impinging on the fusion target, causes pulses of neutrons impinging on the reactor. For example, in one embodiment of the process of the current invention, pulses of neutrons are created by the fusion reaction, where the ³H_{target} is gas in a container, is given by the following equation:

²H_{beam}+³H_{target}→n+⁴He 12

When the hydrogen isotope beam (in equation 12, ²H_{beam}) is energized, neutrons produced by the fusion reaction, Equation 12, cause the reactor to become critical or supercritical, depending on the controllable nature of the beam pulse. It is necessary that the beam particle, ²H_{beam} in this embodiment, stops in the region of the target gas particles, ³H_{target} in this embodiment, because the probability for generating the fusion neutrons is greatest when this is true. The beam energy must be chosen in conjunction with the geometry of the fusion target container such that the beam stops in the fusion target and not in the container wall. In one embodiment of the present invention, a bombarding deuteron beam should enter the gas with at least 140 keV to cover the peak of fusion resonance, which is at or near 100 keV, because the deuteron beam loses energy in the tritium target. This peak in resonant range is taught by Jarmie, Brown and Hardekopf, Physical Review C, Vol. 29, p. 2042, FIG. 11 with supporting text (June, 1984), which is incorporated by reference.

In another embodiment, the beam can be deuterium and the target gas can also be deuterium. In this case the beam should stop in the target, but should as well enter the target with greater kinetic energy than the previous embodiment, this being because (according to present knowledge) there is no broad, low-energy resonance resulting in neutrons of which to take advantage. This means that the design of the target and the overall reactor in this embodiment would have to compensate for the fewer neutrons produced by the reaction:

²H_{beam}+²H_{target}→n+³He 13

For the purposes of the present invention, the necessary physics require that neutrons produced in fusion reactions due to the action of the beam particles incident on the fusion target be capable of escaping the fusion target, and entering the fuel of the reactor. The reactor will go supercritical or critical until the fusion neutron influence dies out. For example, the fusion neutrons undergo nuclear reactions with the fuel, as by fission of the fuel (e.g. ²³⁹Pu). Or also by example, the neutrons may be thermalized by the usual workings of cooling, or may be absorbed by the buildup of fission and reactor products.

For the sub-critical, static case, beam off, cooling steady, k_{eff}<1.000, then:

k_{eff}=n/(1+P+A+L) 14

and

M=1/(k_{eff}−1) 15

It is necessary to define a variable, kappa, as a function of time:

K(t)=n(t)/(1+P+A+L) 16

In the present invention, for example, an accelerator beam, which in one embodiment could be deuterons, is caused to stop within a fusion target, which could be a gas of tritium. The fusion reaction in the fusion target would produce neutrons isotropically, because the fusion reaction is isotropic. In this case, we can define:

K⁽⁺⁾ₜₒₜₐₗ=K⁽⁺⁾_{fusion}+k_{eff} 17

K⁽⁺⁾_{fusion}>0, for beam-on conditions

K⁽⁻⁾_{fusion}=0, for beam-off conditions.

During the period the beam is energized and incident on the fusion target, K⁽⁺⁾ₜₒₜₐₗ can be equal to one or greater than one. The exact value of Kₜₒₜₐₗ is controlled by design of the target and the beam pulse. But when the beam is off, K⁽⁻⁾ₜₒₜₐₗ, while it still may be greater than one for a short while, must necessarily return to the value designed as k_{eff}. The fusion reaction neutrons can burn ²³⁹Pu fuel preferentially, because the fusion neutrons are of higher energy than the normal fission neutrons. Criticality is transient going from K⁽⁺⁾ₜₒₜₐₗ to K⁽⁻⁾ₜₒₜₐₗ. K⁽⁻⁾ₜₒₜₐₗ approaches k_{eff} at a rate determined ultimately by the absorption P, leakage L, fuel A, cooling, and multiplication of reactant neutrons.

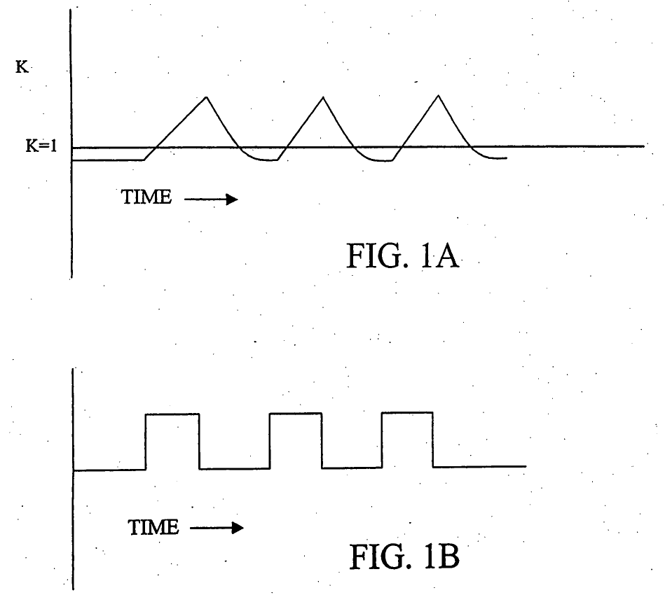

In FIG. 1A, a graph of K versus time for a point in the reactor of the present invention is illustrated. As seen, the reactor before and after a pulse, as shown in FIG. 1B, is sub-critical, operating at k_{eff}<1.000 line. Upon impingement of a pulse, the reactor goes critical or supercritical for a short period before returning to the sub-critical area. Between pulses, the reactor falls to below critical by design of the geometry, the frequency of the accelerator beam particle pulses, the fuel, and the cooling mechanism, all in combination.

One cannot discount other nuclear processes when a beam is incident on a target. Neutrons from processes other than the intended fusion reaction are inevitably created by other nuclear interactions, for example, by breakup of the deuterium atom into one proton and one neutron before it stops in the region of the tritium target. Additionally, if the deuterium beam were to be scattered so that it would be incident on a fissile material before it enters into the region of the tritium target, it itself could be responsible for fission. Finally, if the accelerated beam particle is of high enough energy, (for example 800 MeV) then spallation neutrons could result from interaction with spallation targets. For example, in a region where the fluence of neutrons is due to a beam-on process of spallation:

K⁽⁺⁾(t)=K⁽⁺⁾ₛₚₐₗₗₐₜᵢₒₙ+k_{eff} 18

In this region, the flux is not isotropic. Rather, it depends on the details of the beam and the associated spallation. The spallation-neutron distribution could be thought of as a flux with its intensity distributed conically about the axis of the beam direction.

As a further example, if an embodiment included deuteron-induced fission, denoted using nuclear physics notation as (d,f), yields the following relationship:

K⁽⁺⁾(t)=K⁽⁺⁾_{(d,f)}+k_{eff} 19

The neutron products need not be released isotropically in this process. In the present invention it is necessary that:

K⁽⁺⁾(t)ₜₒₜₐₗ=K⁽⁺⁾_{fusion}+K⁽⁺⁾ₛₚₐₗₗₐₜₒₙ+K⁽⁺⁾_{(d,f)}+k_{eff} 20

fall to the level of k_{eff} after the beam pulse is terminated, and that Kₜₒₜₐₗ necessarily is smaller outside the region of influence of the beam for all times. Control of the criticality of the reactor is by the beam pulse, with the proviso that when the beam is off, the criticality returns to a value less than 1.000.

In the present invention, the value of k_{eff}<1.000 is the steady-sub-critical state of the reactor, where the dynamic component represented by K(t) includes the direct interactions caused by the fusion reaction. For example, consider a neutron born from a fusion process to be incident on the nucleus of ²³⁹Pu:

(neutron created from fusion)+²³⁹Pu→n neutrons+F.F.1+F.F.2 21

The number of neutrons, n, born of the fission reaction further multiply and spread (by scattering or diffusing) away from the point of first interaction. In the same reaction, fission fragments, F.F.1. and F.F.2, are born. Even though the n neutrons multiply as they scatter and diffuse, the reactor by design, with the fusion reaction stopped, will return to sub-criticality, k_{eff}<1.000.

Over the period of many accelerator pulses, it is clear that, on a time scale that is long compared to the time between the pulses, that P (the number of neutrons parasitically absorbed per fission) will increase. This is to be expected. There is a trade-off between P, and the power required by, in one embodiment, an accelerator to drive the sub-critical reactor. The closer the sub-critical reactor is to the critical point (being self-driven) the lower the requirements of the accelerator to produce neutrons.

A single case relevant to the present invention now will be discussed. Let a dynamic source of fusion neutrons be:

²H_{beam}+³H_{target}→⁴He+n, 22

where the kinetic energy of the fusion neutron, n, is 14 MeV. Let that neutron be incident on ²³⁹Pu with an energy of 6 MeV (the difference in energy being deposited by random scattering). There then exists some probability, proportional to the cross-section, that the ²³⁹Pu will fission, thereby destroying itself and releasing energy. There also is a probability that the ²³⁹Pu will permute by way of the reaction:

(neutron)+²³⁹Pu→(two neutrons)+²³⁸Pu. 23

²³⁸Pu has very different proliferation usefulness to terrorists than does ²³⁹Pu.

The intent of the present invention is to maintain a nuclear reactor near, but below k_{eff}=1.000, and to effect criticality by the introduction of high-energy neutrons into the reactor's fuel through the use of a fusion reaction. In one embodiment, this reaction can involve a pulsed beam of deuterons impinging a tritium gas target. The fuel and its immediate environment must be designed so that k_{eff} is slightly less than 1.000, but having the capability of being controlled when the dynamic value of k_{eff}≧1.000 due to an ion pulse inducing fusion reactions in the fuel.

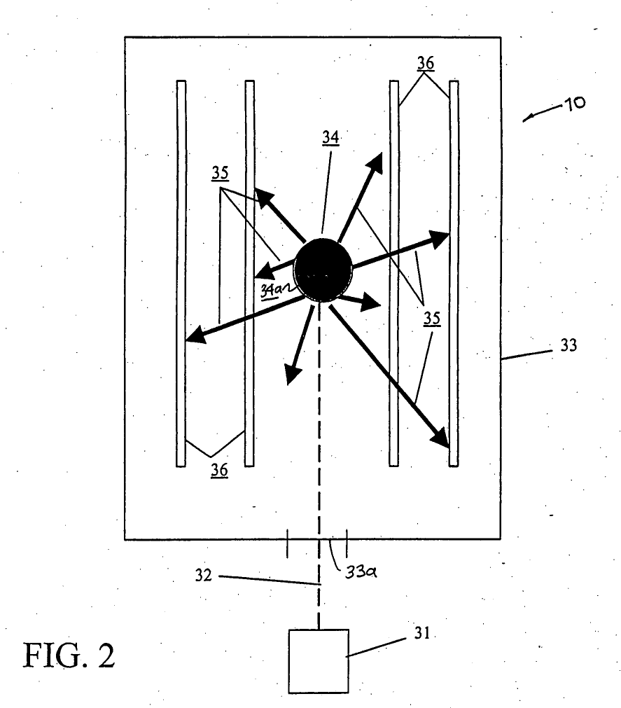

Reference should now be made to FIG. 2, where a schematic illustration of operation of one embodiment of the present invention is shown. As seen, source of energetic hydrogen isotope 31 produces pulses of a beam of a hydrogen isotope 32 that passes through window 33a in housing 33 and strikes fusion target 34. Fusion target 34 is a container with a fusion fuel 34a that is capable of stopping pulses of a beam of a hydrogen isotope 32 within fusion fuel 34a. Upon the impingement of pulses of a beam of a hydrogen isotope 32 on fusion fuel 34a, neutrons 35 are produced isotropically and some impinge upon the surrounding fuel rods 36, and cause reactor 10 to become critical or supercritical for the period of time pulses of a beam of a hydrogen isotope 32 are present. For clarity, only four fuel rods 36 are shown. Additionally, each fuel rod 36 may be surrounded by a moderator fluid (not shown). Upon the completion of each pulse of pulses of a beam of a hydrogen isotope 32, reactor 10 quickly returns to the sub-critical state until the next pulse of pulses of a beam of a hydrogen isotope 32. The ion pulses and the system cooling is designed to allow K(t)ₜₒₜₐₗ>1.000 only due to the effect of an ion pulse. In other embodiments, source of energetic hydrogen isotope 31 could be located inside housing 33.

The fusion fuel 34a may be tritium in the case of pulses of a beam of hydrogen Isotope 32 being tritium. In other embodiments, fusion fuel 34a may be tritium, deuterium or ⁶Li with pulses of a beam of hydrogen isotope 32 being deuterium.

The foregoing description of the embodiments of the invention has been presented for purposes of illustration and description. It is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. Apparatus for providing accurate control of a nuclear reactor containing fuel and designed to be subcritical in the static case comprising:
a vessel, said vessel defining a shell, and an internal volume containing said fuel;
a fusion target located in said internal volume, said fusion target containing a reactive material;
a pulsed source of a hydrogen isotope, said hydrogen isotope being directed into, but stopping within said fusion target;
wherein each pulse of a hydrogen isotope produces a pulse of neutrons from said reactive material in said fusion target that scatter into and burn said fuel, and thereafter said reactor returns to said static case.

2. The apparatus as described in claim 1, wherein said reactive material comprises deuterium.

3. The apparatus as described in claim 1, wherein said reactive material comprises tritium.

4. The apparatus as described in claim 1, wherein said reactive material comprises lithium.

5. The apparatus as described in claim 1, wherein said fuel is spent fuel rods from a nuclear power plant.

6. The apparatus as described in claim 1, wherein said fuel is weapons grade plutonium.

7. The apparatus as described in claim 1 wherein said internal volume is filled with a moderating material around said fuel.

8. The apparatus as described in claim 1, wherein said hydrogen isotope is deuterium.

9. The apparatus as described in claim 1, wherein said hydrogen isotope is tritium.

10. Apparatus for providing accurate control of a nuclear reactor containing fuel and designed to be subcritical in the static case comprising:
a vessel, said vessel defining a shell, a window and an internal volume containing said fuel;
a fusion target located in said internal volume, said fusion target containing a reactive material;
a pulsed source of a hydrogen Isotope, said hydrogen Isotope being directed through said window and into, but stopping within said fusion target;
wherein each pulse of a hydrogen isotope produces a pulse of neutrons from said reactive material in said fusion target that scatter into and burn said fuel, and thereafter said reactor returns to said static case.

11. The apparatus as described in claim 10, wherein said reactive material comprises deuterium.

12. The apparatus as described in claim 10, wherein said reactive material comprises tritium.

13. The apparatus as described in claim 10, wherein said reactive material comprises lithium.

14. The apparatus as described in claim 10, wherein said fuel is spent fuel rods from a nuclear power plant.

15. The apparatus as described in claim 10, wherein said fuel is weapons grade plutonium.

16. The apparatus as described in claim 10, wherein said internal volume is filled with a moderating material around said fuel.

17. The apparatus as described in claim 10, wherein said hydrogen isotope is deuterium.

18. The apparatus as described in claim 10, wherein said hydrogen isotope is tritium.

19. A method for generating pulsed criticality in a nuclear reactor having a vessel containing fuel and designed to be otherwise subcritical, comprising the step of:
directing pulses of deuterium into a fusion target located in the vessel containing tritium or deuterium, the pulses of deuterium stopping within the fusion target;
wherein each pulse of deuterium is effective for producing a pulse of neutrons from the tritium or deuterium in the fusion target that scatters into and burns the fuel, the reactor returning to subcriticality subsequent to the pulse.

20. The method as described in claim 19, wherein said reactive material comprises deuterium.

21. The method as described in claim 19, wherein said reactive material comprises tritium.

22. The method as described in claim 19, wherein said reactive material comprises lithium.

23. The method as described in claim 19, wherein said fuel is spent fuel rods from a nuclear power plant.

24. The method as described in claim 19, wherein said fuel is weapons grade plutonium.

25. The apparatus as described in claim 19, wherein said internal volume is filled with a moderating material around said fuel rods.

26. The method as described in claim 19, wherein said hydrogen isotope is deuterium.

27. The method as described in claim 19, wherein said hydrogen isotope is tritium.

28. The method as described in claim 19, wherein the fuel comprises ²³⁹Pu.

29. The method as described in claim 28, wherein the pulsed criticality nuclear reactor generates power.
